(19) United States
(12) Patent Application Publication
(10) Pub. No.: US 2010/0211440 A1
(43) Pub. Date: Aug. 19, 2010

(54) Managing Vehicle Usage

(76) Inventor: Yoav Leshem, Kfar Saba (IL)

Correspondence Address: The Law Office of Michael E. Kondoudis, 888 16th Street, N.W., Suite 800, Washington, DC, 20006, US

(21) Appl. No.: 12/678,528

(22) PCT Filed: Sep. 21, 2008
(86) PCT No.: PCT/IL08/01263

§ 371 Date: Mar. 17, 2010

Related U.S. Application Data
(60) Provisional application No. 60/960,202, filed on Sep. 20, 2007.

(51) Int. Cl. G06Q 50/00; G07B 15/00; G06Q 20/00; G07B 15/02; G06F 19/00

(52) U.S. Cl. 705/13; 705/418; 701/33; 705/44

(57) ABSTRACT

A system and method for managing vehicle usage. One system includes a monitoring device, a position identifying module, a communication module and a dedicated server. The monitoring device includes a display, an activation unit, an application and an identification module. The dedicated server is connected to the monitoring device via the communication module via a communication link The monitoring device and dedicated server are arranged to carry out the method that comprises the stages: (i) enabling a user to activate a monitoring device; (ii) receiving activation notice, user data and location from the monitoring device; (iii) validating user data; (iv) sending an electronic image to the monitoring device; and (v) displaying the electronic image on the monitoring device. The electronic image is sent upon validation of user data and in relation to the location received from the monitoring device, and authenticates vehicle usage conditions.

### CROSS REFERENCE TO RELATED APPLICATION

This application claims the benefit of U.S. Provisional Patent Application 60/960,202 filed on Sep. 20, 2007, which is incorporated herein by reference.

### FIELD OF THE INVENTION

The present invention generally relates to the field of managing usage. More particularly, the present invention relates to managing vehicle usage, e.g. parking.

### BACKGROUND OF THE INVENTION

Current on-street parking payment solutions available today are as follows: the parking meter, scratch cards, pay and display machines, Easy Park (pre-paid electronic device like an in-car meter) and mobile phone parking options. Each and every current solution has at least one major disadvantage (either for the driver and/or for the parking authorities)., including advance preparation of card or coins, large advance payments and top-ups, over payment by drivers, inconvenience of purchase, use and lacking personal security, need of infra structure outlay, inconvenience for inspectors, servicing costs, vandalism, inability to offer differing and dynamic tariffs.

U.S. Pat. No. 6,249,233 which is incorporated herein by reference in its entirety, discloses a vehicle parking network comprises a transmitter-responder device for each subscriber and a complementary box provided with identification marks that can be scanned from the outside.

### BRIEF SUMMARY

The present invention discloses a system and method for managing vehicle usage. One system comprises a monitoring device, a position identifying module, a communication module; and a dedicated server. The monitoring device comprises a display, an activation unit, an application and an identification module. The monitoring device is connected to the dedicated server via the communication module via a communication link. The monitoring device is arranged to: enable a user activate the activation unit, and to send the dedicated server position data from the position identifying module and user related data. The dedicated server is arranged to determine an electronic image relating to the position data, and to send the electronic image to the monitoring device upon receiving the position data and upon validating the user related data. The monitoring device is arranged to display the electronic image for a predefined period. The identification module is arranged to associate the monitoring device with at least one user. The application is arranged to control and mediate communication relating to the display, the activation unit, the identification module, the position identifying module and the communication module. The vehicle usage conditions are authenticated by the electronic image.

One method comprises the stages: (i) associating a monitoring device with at least one user; (ii) enabling the at least one user to activate the monitoring device; (iii) receiving activation notice, user data and location from the monitoring device; (iv) validating user data; (v) sending an electronic image to the monitoring device; and (vi) displaying the electronic image on the monitoring device for a predefined period. The electronic image is sent upon validation of user data and in relation to the location received from the monitoring device, and authenticates vehicle usage conditions.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1A, FIG. 1B and FIG. 1C are block diagrams of a system for managing vehicle usage according to some embodiments of the invention; and

FIG. 2 is a flowchart of a method of managing vehicle usage according to some embodiments of the invention.

### DETAILED DESCRIPTIONS OF SOME EMBODIMENTS OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. In other instances, well-known methods, procedures, components and circuits have not been described in detail so as not to obscure the teachings of the present disclosure.

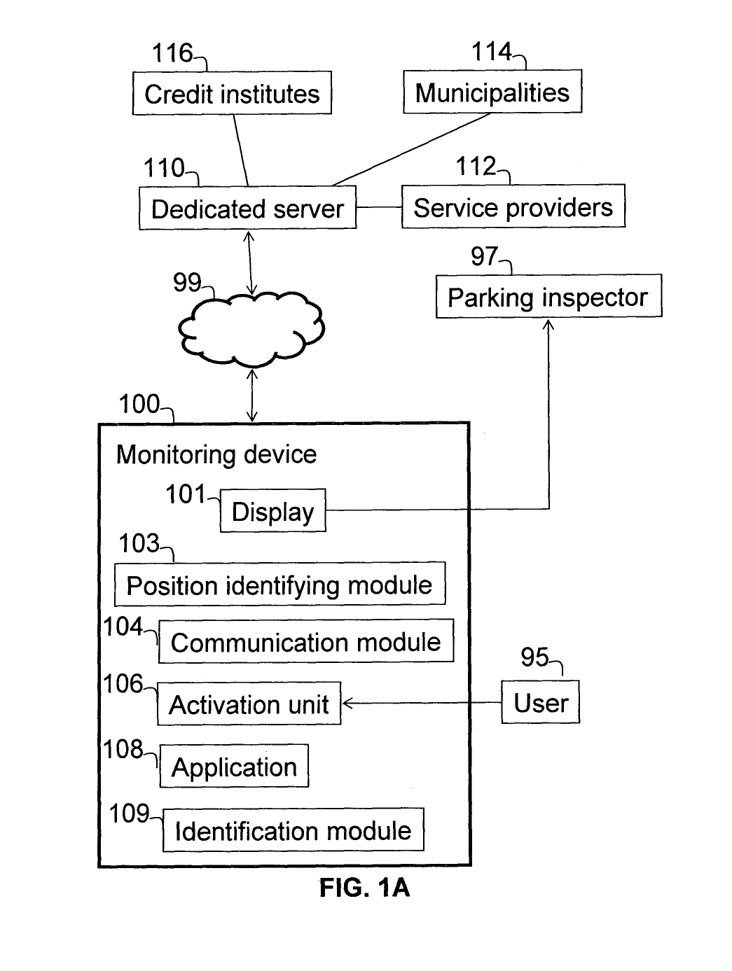

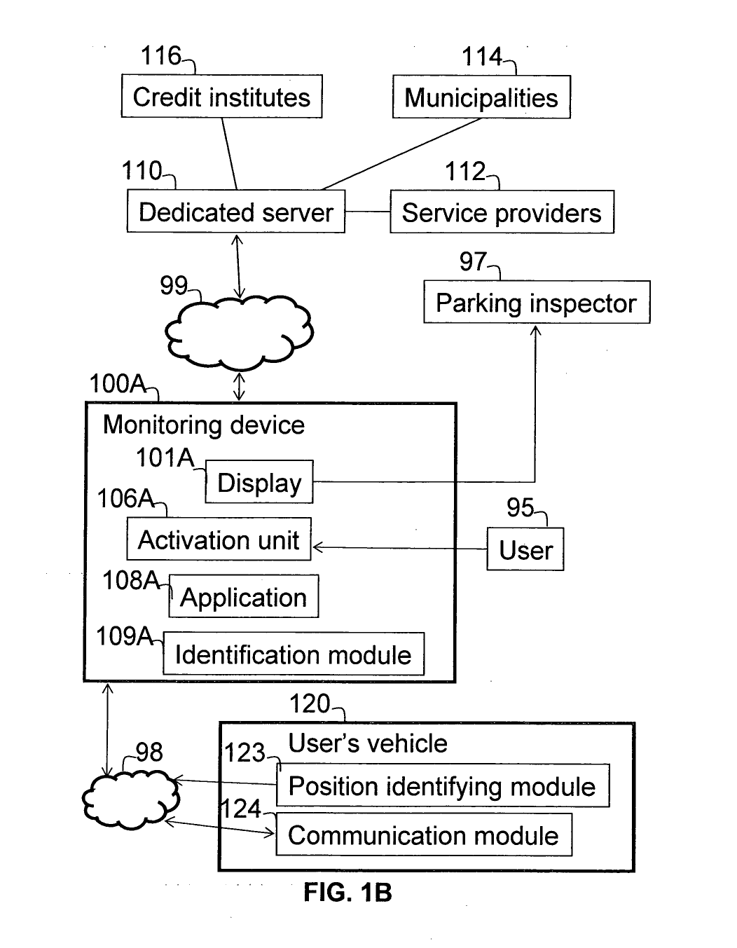

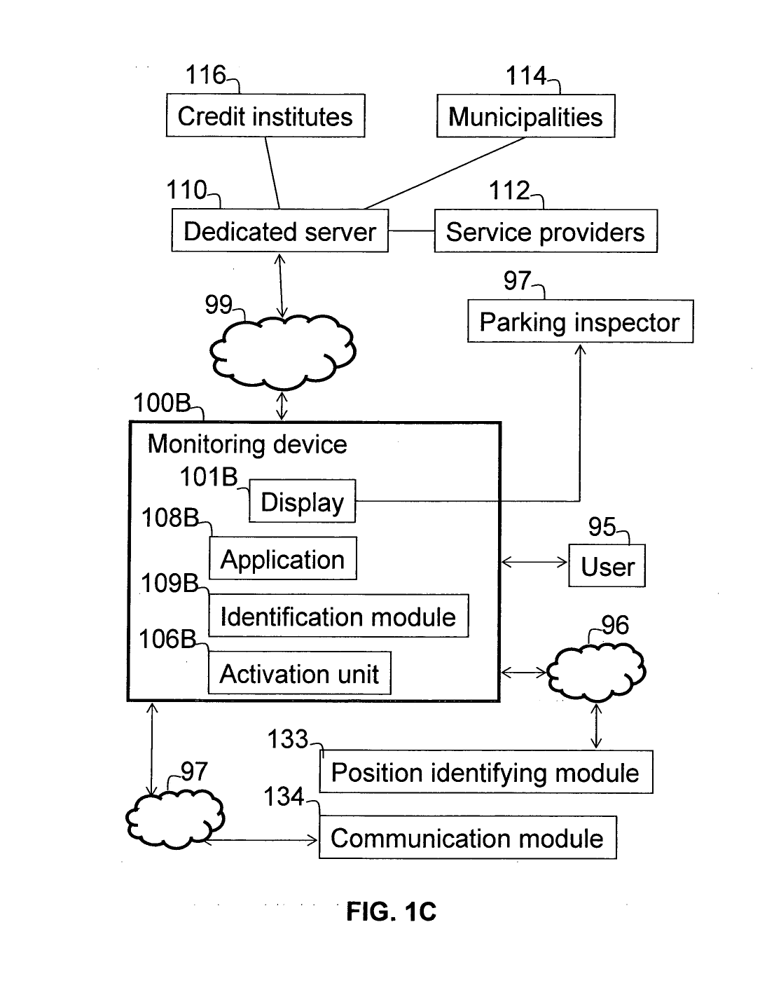

FIG. 1A is a block diagram of a system for managing vehicle usage according to some embodiments of the invention. The system comprises a monitoring device 100 comprising a display 101, an activation unit 106, an identification module 109 and an application 108. The system further comprises and a position identifying module 103, and a communication module 104 which may be part of monitoring device 100. The system further comprises a dedicated server 110 that may be connected to at least one of: credit institutes 116, municipalities 114, service providers 112. The connection may be via a communication link. Monitoring device 100 is connected to dedicated server 110 via communication module 104 via a communication link 99. Monitoring device 100 is arranged to enable a user 95 to activate activation unit 106 and to send dedicated server 110 position data from position identifying module 103 and user 95 related data. Dedicated server 110 is arranged to determine an electronic image relating to the position data, and to send monitoring device 100 an electronic image upon receiving the position data and upon validating the user related data. Monitoring device 100 is arranged to display the electronic image on display 101, e.g. for a predefined period. Vehicle usage conditions (e.g. user payment) may be authenticated by the electronic image. Identification module 109 is arranged to associate monitoring device 100 with at least one user, e.g. user 95, for example to relate payments with a defined payer, relate a different user with a firm account, and so on. Application 108 is arranged to coordinate and control the activity of monitoring device 100, i.e. to control and mediate communication relating to display 101, activation unit 106, identification module 109, position identifying module 103, and communication module 104.

FIG. 1B is a block diagram of a system for managing vehicle usage according to some embodiments of the invention. The system comprises a monitoring device 100A comprising a display 101A, an activation unit 106A, an identification module 109A and an application 108A. The system further comprises a position identifying module 123, and a communication module 124 which may be part of a user vehicle 120 and connected to monitoring device 100A via a communication link 98. Other parts of the system are as described in FIG. 1A. Monitoring device 100A may utilize resources of vehicle 120 via communication links.

FIG. 1C is a block diagram of a system for managing vehicle usage according to some embodiments of the invention. The system comprises a monitoring device 100B comprising a display 101B, an activation unit 106B, an identification module 109B and an application 108B. Monitoring device 100B is connected via a first communication link 96 to a position identifying module 133. Monitoring device 100B is connected via a second communication link 97 to a communication module 134. Other parts of the system are as described in FIG. 1A. Either position identifying module 133, communication module 134 or both may be parts of a mobile communication device, e.g. a mobile communication device associated with user 95.

According to some embodiments of the invention, the electronic image is displayed on display 101 substantially immediately after monitoring device 100 sends the position information to dedicated server 110. The electronic image may utilized to authenticate payment for parking in relation to position and time, the latter e.g. by displaying the electronic image for a predefined period. According to some embodiments of the invention, dedicated server 110 may be arranged to send the electronic image to a communication device associated with user 95.

According to some embodiments of the invention, monitoring device 100 is a moveable device that may be attached to a vehicle, carried by a user, moved between vehicles, or associated with either vehicle or user.

According to some embodiments of the invention, dedicated server 110 may be arranged to determine the electronic image by selecting an electronic image from a list supplied from credit institutes 116, municipalities 114, or service providers 112. Dedicated server 110 may be arranged to determine the electronic image by creating an electronic image (e.g. on the fly) and sharing it with any of: credit institutes 116, municipalities 114, or service providers 112, or their representatives, such as parking inspectors. According to some embodiments of the invention, dedicated server 110 may be arranged to interchange or update the electronic image after predefined periods or every once in a while.

According to some embodiments of the invention, the system further comprises appliances for parking inspectors that may be arranged to receive the electronic image from dedicated server 110, either created electronic images or currently and locally electronic images in force.

According to some embodiments of the invention, the system may be utilized for managing parking. A parking inspector may verify correct payment (e.g. payment for pacing time and location of the vehicle) by identifying the electronic image or comparing the electronic image with predefined images corresponding to the location of parking, valid tariffs, etc.

According to some embodiments of the invention, user 95 may activate monitoring device 100 remotely. For example, user 95 may pay for more parking time, enable a different person use the vehicle etc. Monitoring device 100 may be further arranged to receive activation commands remotely via communication module 104.

According to some embodiments of the invention, the location of monitoring device 100 (and the vehicle) may be received upon calling dedicated server 110.

According to some embodiments of the invention, the electronic image may relate to position data of the vehicle, e.g. be adapted to a parking zone in a city. The electronic image may be defined by municipalities 114 or service providers 112 and be changed arbitrarily. The electronic image may comprise user data such as parking permits and municipality related data which may be integrated in the electronic image. Parking inspectors 97 may receive updates of valid electronic images regularly. According to some embodiments of the invention, the electronic image may comprise a partial image, to be completed by a complementary image sent to parking inspector 97.

According to some embodiments of the invention, monitoring device 100 may receive information relating to parking inspector 97, and communicate this information to dedicated server 110. For example, monitoring device 100 may report to dedicated server 110 parking inspectors 97 inspecting it, e.g. send dedicated server 110 data relating to authentication checks by parking inspectors 97.

According to some embodiments of the invention, dedicated server 110 may be part of a parking unit (such as a parking meter, a payment apparatus in a parking facility). Upon user payment such as activation of the parking unit) dedicated server 110 may send the electronic image to monitoring device 100.

According to some embodiments of the invention, user 95 may purchase monitoring device 100 from a local vendor. Upon purchase, user 95 registers at dedicated server 110 by providing driver and vehicle registration information, payment information and a unique ID code which is marked on monitoring device 100 or included in identification module 109. The vehicle. (with monitoring device 100) may park in the desired parking place. When activation unit 106 is activated (e.g. an ON/OFF button pressed), a message may automatically be sent to dedicated server 110 with the ID of user 95 and the location identified by position identification module 103 (e.g. a GPS connection). Dedicated server 110 may then check the validity of this request—i.e. whether user 95 is registered, whether the payment information is available, etc. If invalid, an error message may be sent to user 95. If valid, dedicated server 110 may open a record in the database for this parking session, which may include the time and location. An authentication message may be sent to monitoring device 100 with an electronic image as a password, which could be a picture, a number, text or a combination of these, which may be changed intermittently. This password gives parking inspector 97 the proof of user payment and helps to eliminate any fraud or fraudulent replicas of monitoring device 100. Dedicated server 110 may have software that generates or selects the authentication message according to rules that may be predefined by the customer of the system (e.g. municipalities 114). The rules could be specified by: time, location, type of users etc., and the update messages could be a dynamic process. Dedicated server 110 may also be able to send the current password to a predefined list of parking inspectors 97 through their mobile phones. Parking inspectors 97 can then easily identify valid users based on the electronic image. Invalid users may then be issued with a parking fine. The authentication message via display 101 could be used also as an advertising media which again could be time, location, type of users depended. The authentication message may be encrypted and may include updates information for user 95. Upon leaving the parking, user 95 may deactivate activation unit 106 (e.g. push the ON/OFF button on monitoring device 100 again), and this may send a message to dedicated server 110 with a unique ID of monitoring device 100. Dedicated server 110 may send back a authentication message that the termination request has been accepted and may note the time of the request. The specific parking session may be closed in dedicated server 110 and the unique password may disappear from display 101. Identification module 109 may be used by either the system provider, parking inspector 97 or service providers 112 to confirm authenticity of monitoring device 100.

According to some embodiments of the invention, activation unit 106 may be activated either by user 95 or by application 108 upon position identification by position identifying module 103 according to predefined rules. For example, activation unit 106 may be automatically activated upon entering a parking facility, as identified by position identifying module 103.

According to some embodiments of the invention, credit institutes 116 may provide billing services as well as confirmation and validation services relating to user 95. Municipalities 114 may provide different parking tariffs relating to location and timings of parking (e.g. different parking zones and locations, time dependency of tariffs, user related tariffs etc.). Municipalities 114 may receive parking data for purposes of improving parking management (e.g. globally managing parking places and tariffs).

According to some embodiments of the invention, service provider 112 may comprise any business or retailer—for example stores at a gas station, services offered at a gas station, car wash facilities and so forth. Service providers 112 may relate to the system in different ways. User 95 payment for different vehicle related services (e.g. refueling, car wash) from service providers 112 may be authenticated via the system. The system may be used to offer users 95 different services from service providers 112.

According to some embodiments of the invention, the system may be used to authenticate the driver of the vehicle. The electronic image may indicate an allowed user.

According to some embodiments of the invention, dedicated server 110 can support flexible, dynamic tariffs, and these can be defined by the relevant municipalities 114 or parking authorities according to time of the day, location or zone, and even special promotions e.g. events where parking can either be more expensive or completely free, etc. Different price groups for different groups of drivers (e.g. seniors, students, disabled drivers etc.) can also be maintained. Both registered users as well as a list of blocked or fraudulent users may be managed by dedicated server 110. Registered users can be invoiced for the parking on a daily, weekly or monthly basis. Payments are possible through credit card, pay pal, or a direct bank connection, any of which supported by credit institutes 116. Dedicated server 110 may also support corporate accounts e.g. a company can purchase a number of monitoring devices 100 for the company vehicles, and can choose to receive only one invoice. The company can even stipulate which times and which locations they are willing to pay for, and the system will automatically split the amount owing between the corporate and private invoices accordingly.

According to some embodiments of the invention, monitoring device 100 may be arranged to be activated remotely by a mobile communication device, e.g. by user 95. Furthermore, monitoring device 100 may be arranged to enable identification of the association of the monitoring device with the user by a mobile communication device, e.g. for prohibiting theft and fraud.

According to some embodiments of the invention, the system may further comprise a module or identifying vehicle movements, or be connected to a data source in the vehicle indicating such a movement. Upon moving the vehicle, display 101 may quit displaying the electronic image.

According to some embodiments of the invention, monitoring device may be connected to an energy source, such as a battery, a vehicle's battery, a solar panel.

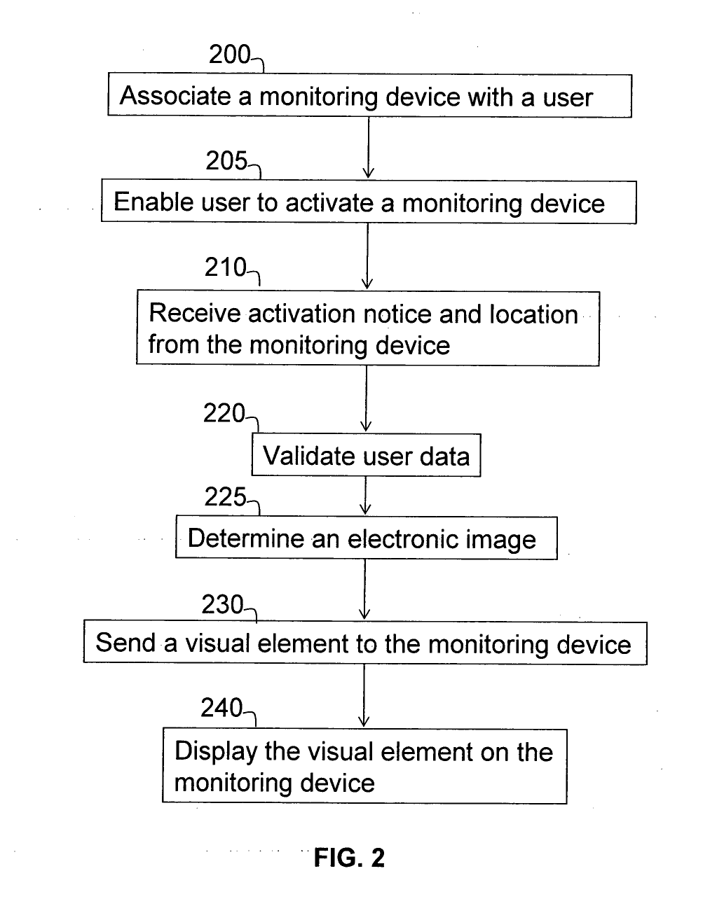

FIG. 2 is a flowchart of a method of managing vehicle usage according to some embodiments of the invention. The method comprises the stages:
Associating a monitoring device with at least one user (stage 200), and according to some embodiments also with at least one vehicle.
Enabling a user to activate the monitoring device (stage 205).
Receiving activation notice, user data and location from the monitoring device (stage 210).
Validating user data (stage 220).
Determining an electronic image relating to the user data and location (stage 225).
Sending an electronic image to the monitoring device (stage 230).
Displaying the electronic image on the monitoring device for a predefined period (stage 240).

According to some embodiments of the invention, sending an electronic image to the monitoring device (stage 230) is carried out upon validation of user data (stage 220) and in relation to the location received from the monitoring device (stage 210). The method may further comprise sending the electronic image to a communication device associated with user. The method may further comprise sending the location of the monitoring device to a requesting party (such as the user, or service providers associated by the user—e.g. a tow truck).

According to some embodiments of the invention, the method may further comprise receiving location data from a position identifying module associated with at least one of: the monitoring device, the vehicle, a mobile communication device.

According to some embodiments of the invention, displaying the electronic image on the monitoring device (stage 240) is carried out substantially immediately after receiving activation notice, user data and location from the monitoring device (stage 210).

According to some embodiments of the invention, the method may further comprise carrying out the communication between the monitoring device and the dedicated server by utilizing a communication module associated with at least one of: the monitoring device, the vehicle, a mobile communication device.

According to some embodiments of the invention, the method may further comprise at least one of: Enabling the user to activate the monitoring device, activating the monitoring device automatically, upon position identification and according to at least one predefined rule (such as entrance to a parking facility).

According to some embodiments of the invention, the electronic image is used to authenticate user payment in relation to position and time, and vehicle usage conditions. According to some embodiments of the invention, the electronic image may be interchanged or updated after predefined periods. Determining an electronic image relating to the user data and location (stage 225) may comprise updating the electronic image relating to a database every once in a while.

According to some embodiments of the invention, vehicle usage may comprise parking, receiving services (e.g. refueling, car wash etc.), driver authentication.

According to some embodiments of the invention, the method may further comprise sending the location of the monitoring device to the user upon request, or to any requesting party. According to some embodiments of the invention, the method may further comprise receiving location data from the vehicle. According to some embodiments of the invention, the method may further comprise utilizing a communication module in the vehicle to carry out communication between the monitoring device and the dedicated server. According to some embodiments of the invention, the method may further comprise enabling identification of the association of the monitoring device with the at least one user by a mobile communication device.

According to some embodiments of the invention, the method may further comprise enabling service providers offer services via the monitoring device. The method may further comprise authenticating payment for services to service providers.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A system for managing vehicle usage comprising:
a monitoring device comprising:
a display;
an activation unit;
an application; and
an identification module,
a position identifying module;
a communication module; and
a dedicated server;
wherein the monitoring device is connected to the dedicated server via the communication module via a communication link;
wherein the activation unit is arranged to activate the monitoring device;
wherein the monitoring device is arranged to send the dedicated server position data from the position identifying module and user related data,
wherein the dedicated server is arranged to determine an electronic image relating to the position data, and to send the electronic image to the monitoring device upon receiving the position data and upon validating the user related data;
wherein the monitoring device is arranged to display the electronic image for a predefined period;
wherein the identification module is arranged to associate the monitoring device with at least one user;
wherein the application is arranged to control and mediate communication relating to the display; the activation unit; the identification module; the position identifying module; and the communication module; and
wherein vehicle usage conditions are authenticated by the electronic image.

2. The system of claim 1, wherein the dedicated server is further arranged to send the electronic image to a communication device associated with the at least one user.

3. The system of claim 1, wherein the activation unit is arranged to be activated by the user.

4. The system of claim 1, wherein the application is arranged to activate the activation unit upon position identification by the position identifying module according to at least one predefined rule.

5. The system of claim 1, wherein the vehicle usage conditions comprise user payment for parking.

6. The system of claim 1, wherein the monitoring device further comprises at least one of: the position identifying module, the communication module.

7. The system of claim 1, wherein at least one of: the position identifying module; and
the communication module, are parts of the vehicle's systems.

8. The system of claim 1, wherein at least one of: the position identifying module; and
the communication module, are parts of a mobile communication device.

9. The system of claim 1, wherein the system is utilized for managing parking of vehicles, and wherein the electronic image is utilized to authenticate payment for parking in relation to position and time by at least one parking inspector.

10. The system of claim 8, wherein the monitoring device is further arranged to send the dedicated server data relating to authentication checks by the at least one parking inspector.

11. The system of claim 1, wherein the monitoring device is arranged to be activated remotely by a mobile communication device.

12. The system of claim 1, wherein the monitoring device is arranged to enable identification of the association of the monitoring device with the at least one user by a mobile communication device.

13. The system of claim 1, wherein the electronic image is displayed on the display substantially immediately after the monitoring device sends the position information to the dedicated server.

14. The system of claim 1, wherein the electronic image relates to at least one of: position data of the vehicle, user data.

15. The system of claim 1, wherein the dedicated server is part of a parking unit and wherein the dedicated server is arranged to send the electronic image to the monitoring device upon activation of the parking unit.

16. The system of claim 1, wherein the dedicated server is connected to at least one of:
credit institutes, municipalities, service providers.

17. The system of claim 15, wherein payment for services of the service providers is authenticated by the electronic image.

18. A method of managing vehicle usage comprising:
associating a monitoring device with at least one user;
receiving an activation notice, user data and location from the monitoring device;
validating user data;
determining an electronic image relating to the user data and location,
sending an electronic image to the monitoring device; and
displaying the electronic image on the monitoring device for a predefined period, wherein the electronic image is sent upon validation of user data and in relation to the location received from the monitoring device; and
wherein the electronic image authenticates vehicle usage conditions.

19. The method of claim 17, further comprising sending the electronic image to a communication device associated with the at least one user.

20. The method of claim 17, further comprising enabling the at least one user to activate the monitoring device.

21. The method of claim 17, further comprising activating the monitoring device automatically, upon position identification and according to at least one predefined rule.

22. The method of claim 17, further comprising associating the monitoring device with at least one vehicle.

23. The method of claim 17, wherein the vehicle usage conditions comprise user payment for parking.

24. The method of claim 17, wherein said displaying the electronic image is carried out substantially immediately after said receiving activation notice, user data and location from the monitoring device.

25. The method of claim 17, wherein said determining an electronic image comprises updating the electronic image at predefined periods.

26. The method of claim 17, further comprising sending the location of the monitoring device to a requesting party.

27. The method of claim 17, further comprising receiving location data from a position identifying module associated with at least one of: the monitoring device, the vehicle, a mobile communication device.

28. The method of claim 17, further comprising carrying out the communication between the monitoring device and the dedicated server by utilizing a communication module associated with at least one of: the monitoring device, the vehicle, a mobile communication device.

29. The method of claim 17, further comprising enabling service providers offer services via the monitoring device.

30. The method of claim 17, further comprising authenticating payment for services to service providers.

31. The method of claim 17, further comprising enabling identification of the association of the monitoring device with the at least one user by a mobile communication device.
